(19) United States
(12) Patent Application Publication
(10) Pub. No.: US 2017/0254324 A1
(43) Pub. Date: Sep. 7, 2017

(54) Gravitational inversion pump

(71) Applicant: Clayton Hemmerle, Ft. Lauderdale, FL (US)

(72) Inventor: Clayton Hemmerle, Ft. Lauderdale, FL (US)

(21) Appl. No.: 15/446,567

(22) Filed: Mar. 1, 2017

Related U.S. Application Data
(60) Provisional application No. 62/301,931, filed on Mar. 1, 2016.

(51) Int. Cl. F04B 45/033; F03B 7/00; H02K 7/18; F04B 35/01

(52) U.S. Cl. CPC F04B 45/033; F04B 35/01; F03B 7/00; H02K 7/1807; F05B 2260/4031; F05B 2220/706; F03B 17/04

(57) ABSTRACT

Disclosed is a gravitational inversion pump wherein a wheel is turned by combination of the force of gravity and the power of buoyancy. The inversion pump employs a rocker arm attached to a wheel frame with a pivotal pin which causes a pump to move up and down. The rocker arm has a weight at one end relying upon gravity to move the arm down. The opposite end of the rocker arm employs a float is force up by buoyancy when submersed in a fluid such as water. When the wheel shaped structure is rotated, the bellows in a top position is forced down causing the bellows to deflate and a bellows positioned on an opposite side of the wheel, which will be at the bottom of the wheel, will be inflated. The bellows will become buoyant as it inflates and will pull upwards causing the wheel to move in a circular motion. This action will repeat as the wheel turns and can be used in the generation of rotational movement.

### CROSS-REFERENCE TO RELATED APPLICATIONS

In accordance with 37 C.F.R. §1.76, a claim of priority is included in an Application Data Sheet filed concurrently herewith. Accordingly, the present invention claims priority to U.S. Provisional Patent Application No. 62/301,931, entitled “GRAVITATIONAL INVERSION PUMP”, filed Mar. 1, 2016. The contents of which the above referenced application is incorporated herein by reference.

### FIELD OF THE INVENTION

This invention is related to the field of energy recovery and in particular to a gravity assist inversion pump that can coupled to a motor for generating electricity.

### BACKGROUND OF THE INVENTION

Conventional generators operate on the energy derived from fossil fuels, solar power, wind power or water power. Fossil fuels, such as coal or natural gas, operate combustion chambers capable of operating an electrical generator. Wind energy provides a natural fuel from kinetic energy of the wind but is dependent upon a sustainable wind in order to operate an electric generator. Rivers provide kinetic energy by the natural movement of water, however every body of water includes a water current capable of providing sufficient kinetic energy to turn a generator. The sun provides a passive energy source providing fuel for operating photovoltaic panels capable of generating electric. While each energy source has a benefit, there are also disadvantages. For instance, use of fossil fuels consumes valuable resources and produces polluting by-products. Solar power is dependent upon sunlight making energy production suspect on cloudy days and non-existent at night. Water power can be steady but there are not enough rivers available to provide a substantive power source.

What is needed in the art is a device that is capable of providing power generation using gravity assist.

### SUMMARY OF THE INVENTION

Disclosed is a gravitational inversion pump wherein a wheel frame is rotated by combination of the force of gravity and the power of buoyancy. The inversion pump employs a rocker arm attached to a wheel frame with a pivotal pin which causes a pump device to move up and down. The rocker arm has a weight at one end relying upon gravity to pull the arm down. The opposite end of the rocker arm employs a float that is forced up by buoyancy while submersed in a fluid such as water. A connecting rod coupled to the rocker arm is attached midway to a bellows or piston type pump. Upon rotation, when a portion of the wheel frame reaches an upper position, the bellows is forced down causing the bellows to deflate by passing air through an air line to a bellows positioned on an opposite side of the wheel frame, which will be momentarily at the bottom of the wheel frame. Thus, the bellows that is diametrically positioned to the upper bellows will expand upon the receipt air into the bellows. As the bellows becomes buoyant with air, the bellows will overcome the pull of gravity using buoyancy and will pull the portion of the wheel frame upwards causing the wheel to move in a circular motion. This action will repeat as the wheel turns.

An objective of the instant invention is to provide a gravitational inversion pump that can operate in a body of water.

Another objective of the invention is to provide a gravitational inversion pump that can operate in water that is devoid of any current.

Still another objective of the invention is to provide a scalable pump that can be sized in accordance with the amount of energy to be produced.

Yet another objection of the invention is to provide a device that can be completely immersed in a fluid to eliminate environmental elements, such as wind, from affecting operation of the device.

Other objectives and further advantages and benefits associated with this invention will be apparent to those skilled in the art from the description, examples and claims which follow.

### BRIEF DESCRIPTION OF THE DRAWINGS

FIG. 1 is a pictorial view of the pump.

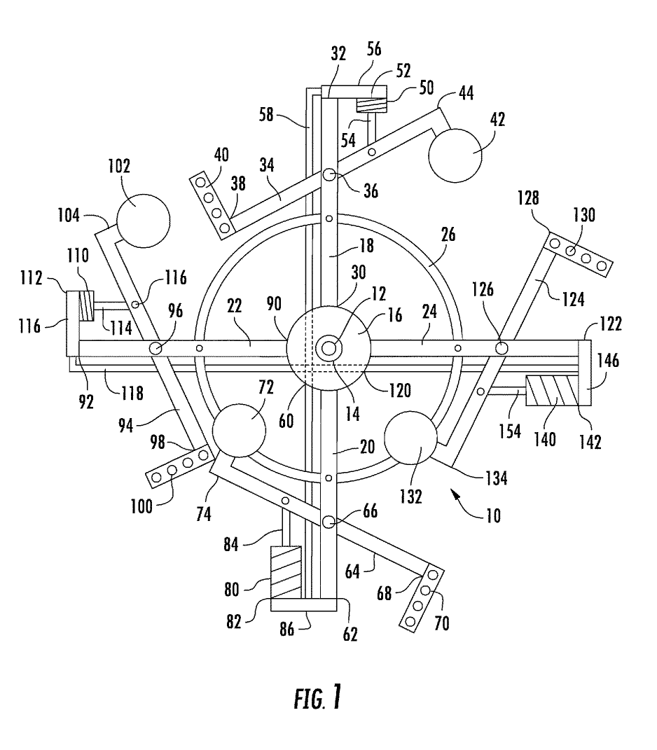

### DETAILED DESCRIPTION OF THE PREFERRED EMBODIMENT

A detailed embodiment of the instant invention is disclosed herein, however, it is to be understood that the disclosed embodiment is merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Disclosed is a gravitational inversion pump 100 that is mounted on a fixed main wheel shaft 12 having a wheel shaft bearing 14 allowing a center support hub 16 to freely spin in relation to the wheel shaft. The center support hub 16 is supported by a first strut 18 extending outward from the hub 16, a second strut 20 extending outwardly opposite said first strut 18, preferably constructed from a single piece of material. The center support hub 16 further supports a third strut 22 placed 90 degrees to said first 18 and second strut 20. A fourth strut extends outwardly from the center support hub 16 opposite said first strut 18 and is also preferably constructed from a single piece of material. An outer support ring 26 is attached to each of the struts providing structural stability to each strut. It should be noted that the use of four struts is but one example and adding additional struts is contemplated in this invention. The preferred embodiment having 16 struts and bellows, however, for ease of illustration the 4 strut embodiment is depicted.

The first strut 18 has a proximal end 30 and a distal end 32 with a first rocker arm 34 pivotally secured to the first strut 18 by a pivot pin 36 at a position between the outer support ring 26 and the distal end 32. The first rocker arm 34 having a first end 38 coupled to a weight 40. In the preferred embodiment the weight is a weighted lead cylinder constructed and arranged to offset a buoyancy float 42 secured to a second end 44 of the strut. The size of the float and the related buoyancy determines the size of the weight. A bellows 50 is operated by having a base 52 is coupled to the distal end 32 of the strut 18 by an offset bracket 56 sized to position the bellows 50 at an optimum displacement position. An internal pump like change is operated by a connecting rod 54 pivotally coupled to the first rocking arm 34. The offset 56 is calculated to provide optimum efficiency of the bellows range of motion. As depicted, bellows 50 is shown in a collapsed position wherein the weight 40 overcomes the weight of the float is negligible when raised. The bellows 50 is sealed with air displacement through an air line 58 to a cooperating bellows which is beneath the water, as depicted with bellows 80.

The second strut 20 has a proximal end 60 and a distal end 62 with a second rocker arm 64 pivotally secured to the second strut by a pivot pin 66 at a position between the outer support ring 26 and the distal end 62. The second rocker arm 64 having a first end 68 coupled to a weight 70. In the preferred embodiment the weight is a weighted lead cylinder constructed and arranged to offset a buoyancy float 72 secured to a second end 74 of the strut 64. The size of the float and the related buoyancy determines the size of the weight and must match the remaining struts. A bellows 80 is operated by having a base 82 coupled to the second end 68 of the strut 20 by an offset 86 sized to position the bellows 80 at a location optimum displacement of an internal bellows operated by a bellows connecting rod 84 pivotally coupled to the second rocking arm 64. The offset 86 is calculated to provide optimum efficiency of the bellows range of motion. As depicted, bellows 80 is shown in an expanded position wherein the buoyancy of the float is able to lift the weight 70 to overcome the gravity pull on the weight until the float is raised. The bellows 80 is sealed with air displacement through air line 58 to cooperating bellows 50 during rotation of the struts.

The third strut 22 has a proximal end 90 and a distal end 92 with a third rocker arm 94 pivotally secured to the third strut 22 by a pivot pin 96 at a position between the outer support ring 26 and the distal end 92. The third rocker arm 94 having a first end 98 coupled to a weight 100. In the preferred embodiment the weight 100 is a weighted lead cylinder constructed and arranged to offset buoyancy float 102 secured to a second end 104 of the strut 94. The size of the float 102 and the related buoyancy determines the size of the weight 100. A bellows 110 is operated by having a base 112 coupled to the second end 92 of the strut 22 by an offset 116 sized to position the bellows 110 at a location providing optimum displacement of an internal air valve by bellows connecting rod 114 pivotally coupled to the third rocking arm 22. The offset 116 is calculated to provide optimum efficiency of the bellows range of motion. As depicted, bellows 110 is shown in a collapsed position wherein the weight 100 overcomes the weight of the buoyancy float which is negligible when the float is raised. The bellows 110 is sealed with air displacement through an air line 118 to a cooperating bellows which is beneath the water, as depicted with bellows 140.

The fourth strut 24 has a proximal end 120 and a distal end 122 with a fourth rocker arm 124 pivotally secured to the fourth strut by a pivot pin 126 at a position between the outer support ring 26 and the distal end 122. The fourth rocker arm 124 having a first end 128 coupled to a weight 130. In the preferred embodiment the weight 130 is a weighted lead cylinder constructed and arranged to offset buoyancy float 132 secured to a second end 134 of the strut 124. The size of the float 132 and the related buoyancy determines the size of the weight 130 and must match the remaining struts. A bellows 140 is operated by having a base 142 coupled to the second end 122 of the strut 124 by an offset 146 sized to position the bellows 140 at a location optimum displacement of an internal bellows operated by a bellows connecting rod 154 pivotally coupled to the second rocking arm 124. The offset 146 is calculated to provide optimum efficiency of the bellows range of motion. As depicted, bellows 140 is shown in an expanded position wherein the buoyancy of the float 132 is able to lift the weight 130 to overcome the gravity pull on the weight until the float 132 is raised during rotation, or when the weight and float is balanced that it allows rotation within the water. The bellows 140 is sealed with air displacement through air line 118 to cooperating bellows 110 during rotation of the struts.

In operation, the inversion pump 10 is turned by a combination of the force of gravity on the weights and the power of buoyancy on the buoys. The rocker arms are attached with the pivot pin which allows the rocker arm to rotate in respect to the mounting struts. The rocker arm has a weight at one end relying upon gravity to move the arm down. The opposite end of the rocker arm employs a float is force up by buoyancy when submersed in a fluid such as water. A connecting rod coupled to the rocker arm is attached midway to a bellows or piston type pump. When the wheel reaches a top position, the bellows is then deflated with air forcing through an air line to a bellows positioned on an opposite side of the wheel, which will be at the bottom of the wheel. The bellows that is diametrically positioned to the top bellows expand upon the placement of air into the bellows. The bellows will become buoyant as it inflates and will pull upwards causing the wheel to move in a circular motion. This action will repeat as the wheel turns. While air is the preferred gas flowing through the bellows, any type of gas or fluid will works as the function of the material is to reposition the material upon the expansion or deflation of the bellows.

The inversion pump 10 is preferably mounted in a body of water, such as a water tank, and secured by the steel shaft 12 supported by two bearings mounted on the sides of the tank. In a preferred embodiment, the entire mechanism is submersed completely. The weighted cylinder and the buoyancy flat are equal and will have no effect on the movement of the wheel. The rotation of the wheel relies upon the inflation and position of the bellows which is optimized when the weight and float are balanced to allow rotation within the water.

Additional pumps may be added to the frame to increase the power of rotation. The torque provided by this system can be converted into electrical energy by connecting a pulley to the wheel shaft 12 and adapting that to a generator or the like machine capable of converting mechanical energy into electrical energy.

It should be noted that the entire mechanism is preferably submersed but may be partially submersed and still operated properly. The weighted cylinder and the buoyancy flat are equal and will have no effect on the movement of the wheel. The rotation of the wheel relies upon the inflation and position of the bellows.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A gravitational inversion pump comprising:
a support structure having a centrally disposed hub securable, said support structure having at least four support struts extending outwardly from said hub with equal spacing between each strut;
a rocker arm pivotally secured to each said strut, said rocker having a first end supporting a weight and a second end supporting a float buoy;
a bellows coupled to an end of each support structure and secured to said rocker arm by a pivoting connecting rod, each said bellows fluidly coupled to a related bellows located along an opposite section of said support structure;
wherein the support structure is turned by the force of gravity pulling on each causing gas to be displaced from an upper bellows to a lower bellows whereby buoyancy from each bellows assists in the turning of said support structure, whereby rotation of the pump can be used to generate electricity.

2. The gravitational inversion pump according to claim 1 wherein a line couples opposing bellows together allowing gas in one bellows to flow to the other bellows.

3. The gravitational inversion pump according to claim 1 wherein each float placed into water is constructed and arranged to expand one of said bellows.

4. The gravitational inversion pump according to claim 1 wherein each said weight is constructed and arranged to deflate one of said bellows.

5. The gravitational inversion pump according to claim 1 wherein said support hub includes a driver for coupling to an electricity generator.

6. The gravitational inversion pump according to claim 5 wherein said driver is a pulley for rotational movement of a belt.

7. The gravitational inversion pump according to claim 5 wherein said driver is a gear for rotational movement of a chain.

8. The gravitation inversion pump according to claim 1 wherein the support wheel is fully immersed a fluid.
